(19) United States
(12) Patent Application Publication
(10) Pub. No.: US 2016/0125858 A1
(43) Pub. Date: May 5, 2016

(54) Decorative Custom Fit Cover for Stringed Instrument

(71) Applicant: Mark Sheldon Porter, Olathe, KS (US)

(72) Inventor: Mark Sheldon Porter, Olathe, KS (US)

(21) Appl. No.: 14/530,829

(22) Filed: Nov. 3, 2014

(51) Int. Cl. G10G 7/00

(52) U.S. Cl. CPC G10G 7/005

(57) ABSTRACT

The stringed instrument cover is primarily used to protect the instrument from dust while it is either in an instrument stand or a hanging holder. The breathable cover offers a way to protect the instrument while allowing the moisture to escape and still enables the instrument to display its beauty.

The cover is made of a transparent vinyl cloth covering the entire face of the instrument with an additional vinyl or leather like material which borders the entire side of the body, neck and head of the instrument.

When the cover is applied, the instrument can be put in a stand, hanging apparatus, hard shell or soft shell case without harming the instrument or modifying the case.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF INVENTION

Stringed instrument cases are usually for protecting the instrument from physical damage when they are not in use. These cases can be made of hard or soft material, but rarely do they allow the instrument to be displayed while simultaneously being protected.

If stringed instruments are not covered, the paint is vulnerable to scratches which will ultimately decrease the instruments value and beauty. These conditions potentially lead to the owners reduced desire to play or own the instrument.

There is a need for an instrument owner to be able to display his or her instrument while protecting it from undesired environmental conditions. This apparatus will allow a stringed instrument limited protection from dust, scratches and moister build-up with a breathable transparent cover.

### BRIEF DESCRIPTION OF DRAWING

For a better understanding of this invention, the following references will be made in conjunction with the accompanying figures in which:

FIG. 1.1 is front elevation perspective of a guitar and stand shown with an instrument cover drawn away from the guitar.

### DETAILED DESCRIPTION OF THE INVENTION

The fitted custom cover is basically made of three materials: transparent or translucent vinyl, a leather or vinyl border strip and a decorative bead chord which outlines the entire case. Vinyl and leather are preferred materials, but some material may be substituted on the border such as Gore-Tex, neoprene, polypropylene or other similar non-abrasive material.

The cover is designed to be custom fitted for the particular design of instrument it will protect. For example; a cover for an acoustic guitar will not be designed to fit any electric guitar and vice versa. Additionally, a cover designed to fit a particular manufacturer of guitar body such as Gibson will not fit the Fender guitars. However, any stringed instrument can be fitted with a custom cover and “upholstered” to fit.

The cover is not designed to be attached to the instrument while the instrument is being tuned or played. Therefore, the instrument cover is useless while the instrument is in use. The cover is designed to fit snug to protect the face of the instrument and aid with beauty retention should the instrument fall or be struck undesirably.

While the cover is attached, any instrument can be placed in an upright stand, hung from a mounted wall hook, or placed inside a hard or soft shell case. Additionally, when the cover is applied it will not interfere with the tuning pegs. This is to prevent excessive tuning after the cover has been applied and removed.

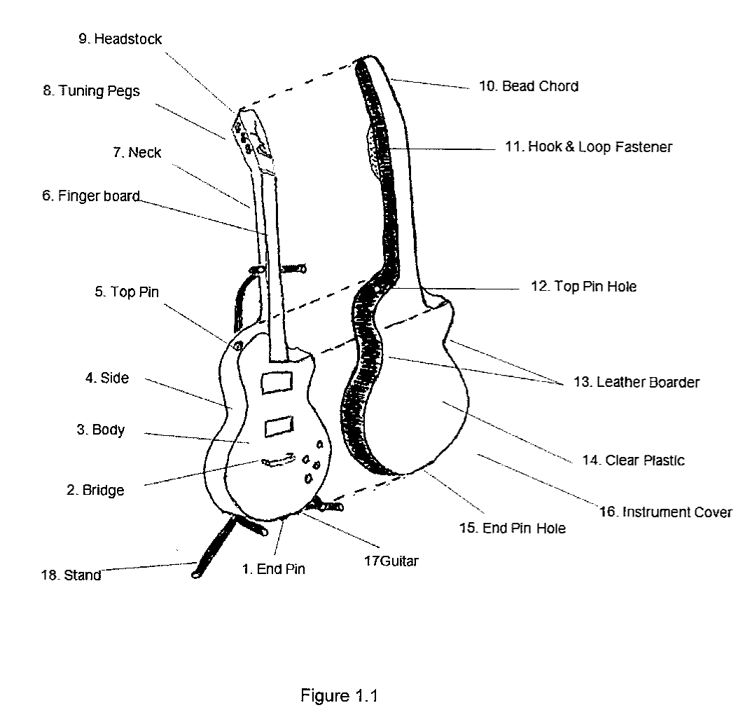

With reference to the drawings, specifically FIG. 1.1, guitar 17 is shown with the cover 16 applied over the face of the guitar. The upper portion of the guitar is covered from the headstock 9 down to the tuning keys 8. The top of the neck 7 is covered with the transparent/translucent material 14 but the side portion of the headstock 9, neck 7 and body 3 are covered with the border 13 constructed of a more dense, non-transparent material such as leather, denim or durable fabric . The border 13 is outlined with a decorative bead chord 10 along the top and bottom edge of the border 13. The transparent vinyl 14 fits snuggly over the Headstock 9, fret board 6 and body 3 of the instrument.

The side border 13 will have a hole 12, 15 lining up with the top pin 5 and the end pin 1 to allow the cover 16 to lock into place on the body 3. Additionally, the cover 16 will have a hook & loop or dual lock fastener 11 on the upper portion of the border 13 which will lock the cover 16 on the neck 7 of the guitar.

1. This product will protect the face of the instrument from scratches and dust when applied as directed.

2. This product will allow ambient moisture to escape and will not trap humidity

3. This cover is designed to fit snug to protect the face of the instrument and aid with beauty retention should the instrument fall or be struck undesirably.

4. While the cover is attached, any instrument can be placed in an upright stand, hung from a mounted wall hook, or placed inside a hard or soft shell case.

5. When the cover is applied it will not interfere with the tuning pegs. Causing excessive tuning after removal.
